(19) United States
(12) Patent Application Publication
(10) Pub. No.: US 2024/0428298 A1
(43) Pub. Date: Dec. 26, 2024

(54) Intelligent Client Support Communication System

(71) Applicant: Jordan Arsenault, North Wiltshire (CA)

(72) Inventor: Jordan Arsenault, North Wiltshire (CA)

(21) Appl. No.: 18/340,831

(22) Filed: Jun. 24, 2023

(51) Int. Cl. G06Q 30/02

(52) U.S. Cl. CPC G06Q 30/0281

(57) ABSTRACT

The present invention describes a client support communication system that enhances communication efficiency between a business and its clients. The system employs a central phone number as the primary channel for text messaging and phone calls. Through a centralized routing and analysis mechanism, the system effectively handles client inquiries and optimally assigns resources within the company. Using a single contact identifier, clients and support agents can send and receive messages via the system. A machine learning-based communication analysis module synthesizes context based on client device communication identifiers and data, determining the most suitable agent for each client. The system facilitates communication by transmitting client data to the assigned agent, storing all communication in a database. It continuously adapts its understanding of evolving context, allowing for precise agent selection. Additionally, an auto-responder agent provides automated support.

### FIELD OF INVENTION

The field of invention for the disclosed system is client support communication systems.

### BACKGROUND OF THE INVENTION

In the digital era, businesses strive to provide effective and timely customer support. Traditional methods, such as phone calls and emails, have limitations in terms of response time and resource allocation. Early attempts to address these challenges involved implementing call centers with manual agent assignments, which often resulted in delays, misrouted calls, and inconsistent customer experiences.

The advent of text messaging introduced a more convenient and asynchronous communication method. However, existing solutions in the form of standalone chat applications or customer relationship management (CRM) systems lacked centralized routing and intelligent analysis capabilities. These limitations led to inefficiencies, prolonged response times, and increased customer frustration.

Over time, advancements in machine learning and natural language processing have contributed to the evolution of customer support systems. Techniques such as sentiment analysis, text classification, and entity recognition have enabled better understanding of customer inquiries and automated responses. Nevertheless, these solutions still lacked a centralized, unified platform that could seamlessly handle both text messaging and phone calls while intelligently routing them to appropriate agents.

Recent developments in communication technologies and customer support systems have paved the way for the invention described herein. The integration of machine learning algorithms has enhanced the ability to analyze communication context and assign suitable agents based on evolving client needs. These algorithms can continuously learn from past interactions and improve response accuracy over time.

Furthermore, the increasing prevalence of mobile devices and the popularity of text messaging have transformed the way customers engage with businesses. Clients expect seamless and prompt communication, regardless of their preferred channel. The ability to handle multimedia messages (MMS) has become essential, as customers often share images, videos, and audio recordings to illustrate their queries or issues.

Moreover, the rise of automated systems and chatbots in customer support has demonstrated the potential for augmenting human agent capabilities. Automation can reduce response times, handle repetitive inquiries, and assist in preliminary issue resolution, contributing to overall efficiency and customer satisfaction.

Despite these advancements, there remains a need for a comprehensive client support communication system that centralizes text messaging and phone calls, intelligently analyzes context, assigns suitable agents, stores communication data, handles multimedia files, and seamlessly integrates automated support.

It is therefore an objective of the disclosed invention to address the challenge of inefficient and fragmented client support communication systems by providing a centralized, intelligent, and unified platform that seamlessly handles text messaging and phone calls, effectively analyzes communication context, assigns suitable agents, stores communication data, and enables the integration of automated support.

### SUMMARY OF THE INVENTION

The following summary is an explanation of some of the general inventive steps for the system, method, devices and apparatus in the description. This summary is not an extensive overview of the invention and does not intend to limit its scope beyond what is described and claimed as a summary.

The present invention introduces a client support communication system that revolutionizes the way businesses interact with their clients. This system utilizes a centralized approach to streamline and optimize communication processes, ensuring efficient handling of client inquiries and effective allocation of resources. At the core of the invention is a central communication system, identifiable by a single contact identifier, which acts as a hub for client support interactions. Clients and support agents can communicate through this system, utilizing text messaging and phone calls.

The system incorporates various components to facilitate seamless communication. A communication receiving means captures messages from clients and support agents, while a communication analysis means employs a trained machine learning algorithm to synthesize the context of each communication. Based on this analysis, a suitable agent is determined to address the client's needs effectively. An exchange means enables the transmission of client communication data to the assigned agent's communication device. Concurrently, a storage means securely stores all communication data exchanged between agents and clients, ensuring a comprehensive record of interactions.

The system is designed to continuously analyze client communication data, allowing for evolving context determination and accurate agent selection. Multiple agents can be connected to the central communication system, each specialized in specific communication contexts. The system dynamically selects the most suitable agent based on the ongoing context, ensuring prompt and appropriate responses to clients.

Furthermore, an auto-responder agent is incorporated into the system, providing automated support based on the specific suitable agent assigned. This enhances efficiency by handling routine inquiries and augmenting the workload of human agents. The system also accommodates multimedia messages (MMS), allowing clients to send and receive media files through the central communication system. This ensures seamless handling and routing of media-based inquiries to the appropriate agent.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 of the drawings illustrates a system diagram for the client support communication system according to one embodiment.

FIG. 2 of the drawings demonstrates communication data interchange according to one embodiment.

FIG. 3 of the drawings illustrates how clients connect to suitable agents and assignment of clients to agents based on context.

FIG. 4 of the drawings illustrates a process diagram for communication data flow between clients and agents.

### DETAILED DESCRIPTION OF THE PREFERRED EMBODIMENTS

Hereinafter, the preferred embodiment of the present invention will be described in detail and reference made to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

In this disclosure, the term exemplary may be construed as to mean embodiments that are provided as examples.

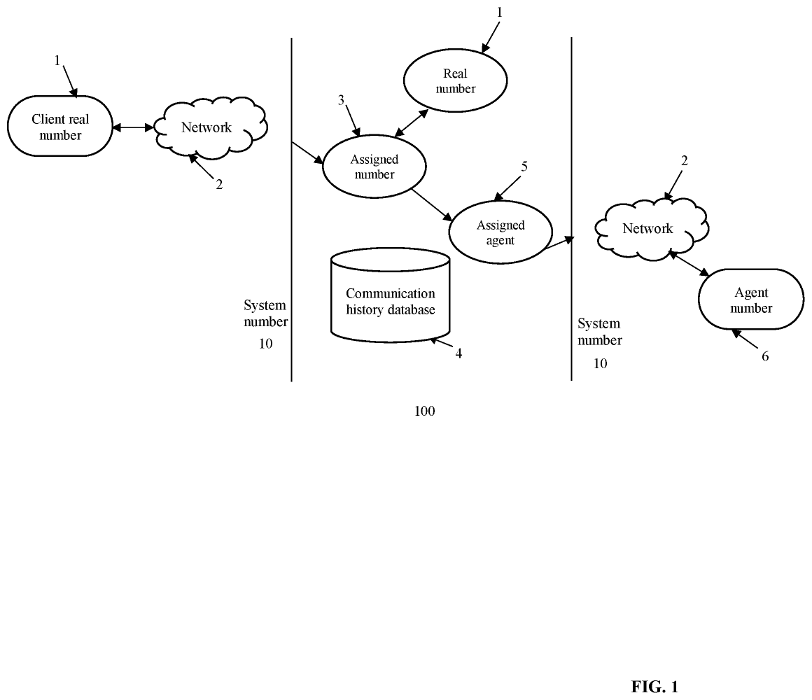

The first shown embodiment according to FIG. 1 of the drawings illustrates a system diagram for the client support communication system according to one embodiment. On the figure it is shown a system 100, where a client with a real number 100 communicates to a central system number 10 via a network 2. Depending on the client or the communication data from the client, an assigned 3 is assigned to respond to the client real number 1 in the system, where the assigned number 3 belongs to an assigned agent 5 found to be most suitable to respond to client communication. The central system number 10 then transmits client communication data to the assigned agent via their real number 6. In some aspects, the assigned 3 and assigned agent number 6 are similar. Also shown on the figure is a database 4 for storing communication history between the client.

In the client support communication system illustrated in FIG. 1, the communication between the client and the assigned agent is facilitated through the central system number 10. The client, identified by their real number 1, initiates communication with the central system number via a network 2. Upon receiving the client's communication, the central system 100 analyzes the client's information and communication data to determine the most suitable agent to assign them to handle the inquiry. This assigned agent is represented by the assigned number 3 within the system.

Once the suitable agent is identified, the central system number 10 transmits the client's communication data to the assigned agent's real number 6. This enables direct communication between the client and the assigned agent, ensuring prompt and effective response. It is important to note that in some aspects, the assigned number 3 and the assigned agent number 6 may refer to the same entity. This implies that the assigned number used for initial communication may correspond to the real number of the agent who will respond to the client.

Also shown, the system includes a database 4, as depicted in the figure, which serves as a repository for storing the communication history between the client and the system. This database allows for the preservation of past interactions, providing a valuable reference for future communications and ensuring a comprehensive record of the client's support history.

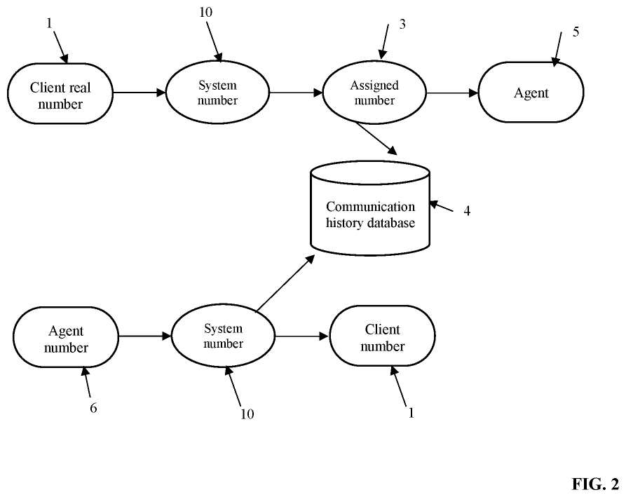

Now referring to the FIG. 2 of the drawings, it is demonstrated communication data interchange according to one embodiment. From a client real number 1, communication data is transmitted to a system number 10, where a suitable agent is determined and the assigned agent number is determined to correspond to an agent 5, the communication is stored in the repository/database 4, on the other hand, communication from the real agent number 6 is transmitted to the system number 10 and then to client number 1.

From a client real number 1, the communication data is transmitted to the system number 10. At this stage, a communication analysis means comes into play. The communication analysis comprises computer program instructions stored on a computer-readable medium and executed by a processor of a computer or server. It synthesizes the communication context by analyzing the client device communication identifier and/or the communication data itself. Based on the determined context, the communication analysis means identifies a suitable agent to receive and respond to the client's communication.

The system further comprises a communication exchange comprising computer program instructions stored on a computer-readable medium and executed by a processor, and which is operably coupled to the communication analysis program to facilitate the transmission of the client device communication data to the suitable agent's communication device. This ensures that the communication is seamlessly delivered to the identified agent, promoting effective and timely response.

Simultaneously, the communication data from the real agent number 6 is transmitted to the system number 10, indicating the agent's response. The central communication system 100 as in FIG. 1 acts as an intermediary, receiving the agent's communication data and is associated with the single contact identifier 10 and transmitting it back to the client's real number 1. This enables a smooth and efficient two-way communication process between the client and the assigned agent. Without limitation, the communication analysis program and the exchange program comprise the central communication system 100 identifiable a single contact identifier 10.

Throughout this communication flow, the storage means, which is part of the central communication system, is responsible for storing and preserving the communication data exchanged between the agents and clients. The storage means serves as a repository or database 4, ensuring the comprehensive record-keeping of all interactions for future reference and analysis.

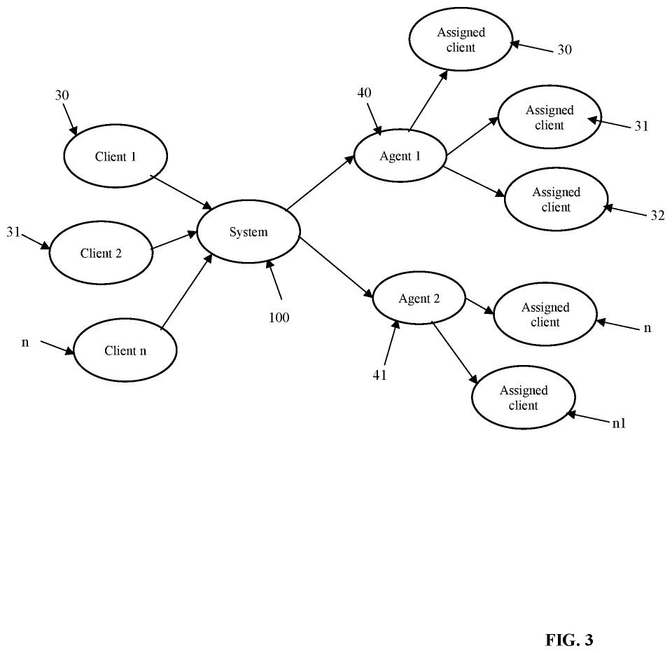

Further, according to the FIG. 3 of the drawings, it is illustrated how clients connect to suitable agents and assignment of clients to agents based on context. A central system 100 is provided to receive communication from the clients 30, 31, all the way to the n^{th} client. Agents 40 and 41 shown are assigned to respond to client communication. For example, agent 1 is assigned to clients 30, 31 and 32, while agent 41 is assigned to clients n and n1. as shown, a plurality of agents are connected to the central communication system. Each agent is specialized and suitable for handling specific communication contexts. This ensures that clients are routed to the most appropriate agent who possesses the necessary expertise to address their inquiries effectively.

In some aspects, a suitable agent is continuously selected based on the ongoing context analysis. This means that as the context evolves, the system dynamically reassesses and reassigns the most suitable agent in real-time, ensuring optimal agent-client matching. As such, the communication analysis means in the client support communication system incorporates a trained machine learning algorithm. This algorithm enables the system to learn from and adapt to various communication patterns and contexts. Through continuous analysis of client communication data, the system can dynamically determine the evolving context of the communication.

In some aspects, the system 100 incorporates an auto-responder agent. This agent is implemented as a computer module specifically designed to respond to client inquiries based on the context and the assigned suitable agent. The auto-responder agent assists in handling routine inquiries, reducing the workload on human agents, and increasing the overall responsiveness of the system.

By incorporating a trained machine learning algorithm, continuously analyzing client communication data, dynamically selecting suitable agents, and including an auto-responder agent, the client support communication system provides an intelligent and efficient framework for managing client support interactions. These features contribute to enhanced agent selection, improved response times, and overall customer satisfaction.

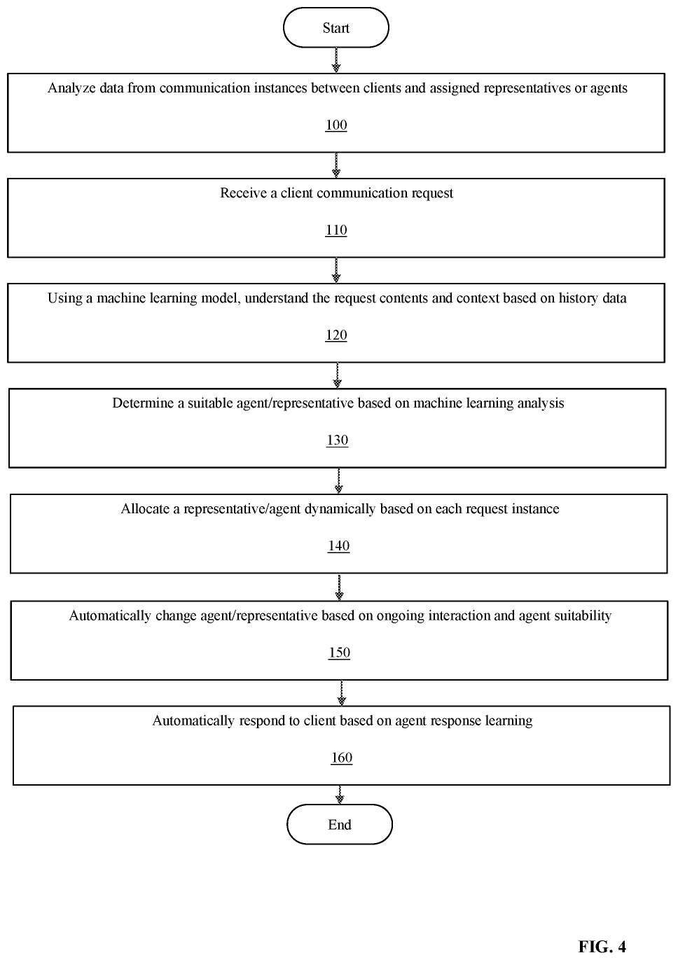

Now referring to the FIG. 4 of the drawings is a process diagram for communication data flow between clients and agents. Beginning at step 100 is the analyzing data from communication instances between clients and assigned representatives or agents as stored in a communication repository or database. Shown as step 110 is the receiving by a communication analysis means communication data to a single system number from one or more clients. Typically, a client will have a real number from which communication is transmitted in the form of voice, short message, email, MMS or some other form of communication. In the step 120 is the use of a trained machine learning model, to understand the contents and context of received communication based on history data.

Subsequently, in the step 130 is the determining of a suitable agent/representative based on a machine learning analysis to respond to client. Next in 140 is the allocating representative/agent dynamically based on each request instance. In some aspects, it may be preferable that a suitable agent is continuously selected based on the ongoing context analysis. This means that as the context evolves, the system dynamically reassesses and reassigns the most suitable agent in real-time, ensuring optimal agent-client matching. Shown in 150 is the changing of agent/representative based on ongoing interaction and agent suitability.

Further shown as 160, is the automatic responding to client based on agent response learning by an auto-responder agent. This agent is implemented as a computer module specifically designed to respond to client inquiries based on the context and the assigned suitable agent. The auto-responder agent assists in handling routine inquiries, reducing the workload on human agents, and increasing the overall responsiveness of the system.

According to one embodiment, the system can be implemented as a client-server model with a server having processing power. It is anticipated that some embodiments of the disclosed invention may be a system, a method, and/or a computer program product at any possible technical detail level of integration. The computer program product may include a computer readable storage medium (or media) having computer readable program instructions thereon for causing a processor to carry out aspects of the present invention.

It is anticipated that blocks in flowchart illustrations and/or block diagrams, and combinations of blocks in the flowchart illustrations and/or block diagrams, can be implemented by computer readable program instructions.

It is further anticipated that where computer readable program instructions are provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. As such, computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Although a preferred embodiment of the present invention has been described for illustrative purposes, those skilled in the art will appreciate that various modifications, additions and substitutions are possible, without departing from the scope and spirit of the invention as disclosed in the accompanying claims. Such alterations are herewith anticipated.

Accordingly, the applicant intends to embrace all such alternatives, modifications, equivalents and variations that are within the spirit and scope of the disclosed subject matter. It should also be understood that references to items in the singular should be understood to include items in the plural, and vice versa, unless explicitly stated otherwise or clearly from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

### INDUSTRIAL APPLICATION

The disclosed client support communication system has wide-ranging industrial applications across various sectors and industries. The system finds particular utility in customer service departments, call centers, and support centers, where effective communication with clients is crucial for maintaining high customer satisfaction levels. Additionally, industries such as e-commerce, health-care, telecommunications, financial services, and technology can greatly benefit from this system.

What is claimed is:

1. A client support communication system, comprising:
a communication receiving means identifiable to a single contact identifier, and adapted to receive communication from clients and support agents to the single contact identifier;
a communication analysis means comprising of computer program instructions stored on a non-transitory computer readable medium, and executable by a processor to enable the synthesizing of communication context based on at least a client device communication identifier and/or communication data, and determine a suitable agent to receive communication based on determined context and respond to clients;
an exchange means operably coupled to the communication analysis means adapted to transmit client device communication data to a suitable agent communication device identifiable to such an agent; and
a storage means adapted to store communication data from agents and clients, wherein:
the communication analysis means and the exchange means comprise a central communication system identifiable a single contact identifier;
a client communication device transmits and receives communication data to the central communication system;
an agent communication device transmits and receives communication data to the central communication system; and
the central communication system transmits client communication data to a suitable agent, and receives agent communication data to the single contact identifier and transmits to the client from single contact identifier.

2. The system of claim 1, wherein the communication analysis means comprises a trained machine learning algorithm.

3. The system of claim 2, wherein the communication analysis means continuously analyzes client communication data to determine evolving context.

4. The system of claim 3, wherein a plurality of agents are connected to the central communication system, each suitable for a determined communication context.

5. The system of claim 4, wherein a suitable agent is selected continuously based on the context.

6. The system of claim 4, further comprising an auto-responder agent comprising a computer module adapted to respond as an agent based on the specific suitable agent.

7. A computer program product for implementing a client support communication system, the computer program product comprising a non-transitory computer-readable storage medium having computer-readable program code embodied therewith, the computer-readable program code executable by at least a processor to implement a communication system comprising of:
a communication receiving means identifiable to a single contact identifier, and adapted to receive communication from clients and support agents to the single contact identifier;
a communication analysis means to enable the synthesizing of communication context based on at least a client device communication identifier and/or communication data, and determine a suitable agent to receive communication based on determined context and respond to clients;
an exchange means operably coupled to the communication analysis means adapted to transmit client device communication data to a suitable agent communication device identifiable to such an agent; and
a storage means adapted to store communication data from agents and clients, wherein:
the communication analysis means and the exchange means comprise a central communication system identifiable a single contact identifier;
a client communication device transmits and receives communication data to the central communication system;
an agent communication device transmits and receives communication data to the central communication system; and
the central communication system transmits client communication data to a suitable agent, and receives agent communication data to the single contact identifier and transmits to the client from single contact identifier.

8. The computer program product of claim 7, wherein the communication analysis means comprises a trained machine learning algorithm.

9. The computer program product of claim 8, wherein the communication analysis means continuously analyzes client communication data to determine evolving context.

10. The computer program product of claim 9, wherein a plurality of agents are connected to the central communication system, each suitable for a determined communication context.

11. The system of claim 10, wherein a suitable agent is selected continuously based on the context.

12. The computer program product of claim 10, further comprising an auto-responder agent comprising a computer module adapted to respond as an agent based on the specific suitable agent.

13. A method for a client support communication system comprising the steps of:
receiving by a communication analysis means communication from clients to a single contact identifier;
analyzing by a communication analysis means communication context based on client device communication identifier and/or communication data;
determining by a communication analysis means a suitable agent to receive communication based on determined context;
transmitting by exchange means from the single contact identifier client communication data to the suitable agent communication device;
receiving to a single contact identifier communication from suitable agent; and
transmitting by exchange means from the single contact identifier suitable communication data to the client communication device.

14. The method of claim 13, further comprising storing communication data from agents and clients.

15. The method of claim 13, wherein the communication analysis means and the exchange means comprise a central communication system identifiable to a single contact identifier.

16. The method of claim 15, wherein the communication analysis means continuously analyzes client communication data to determine evolving context.

17. The method of claim 16, wherein a plurality of agents are connected to the central communication system, each suitable for a determined communication context.

18. The method of claim 17, wherein a suitable agent is selected continuously based on the context.

19. The method of claim 17, further comprising responding by an auto-responder agent comprising a computer module adapted as an agent based on the specific suitable agent.
